(19) United States
(12) Patent Application Publication
(10) Pub. No.: US 2020/0090343 A1
(43) Pub. Date: Mar. 19, 2020

(54) ESTABLISH DEVICE CONNECTION BASED ON DETECTING A MOVEMENT PATTERN ON A CAMERA

(71) Applicant: Motorola Mobility LLC, Chicago, IL (US)

(72) Inventors: Sudhir C. Vissa, Bensenville, IL (US); Vivek K. Tyagi, Chicago, IL (US); Jatinder Kumar, Cary, NC (US)

(21) Appl. No.: 16/134,567

(22) Filed: Sep. 18, 2018

(51) Int. Cl. G06T 7/20; G06K 9/00; G06F 3/01; H04W 76/11

(52) U.S. Cl. CPC G06T 7/20; H04W 76/11; G06F 3/017; G06K 9/00536

(57) ABSTRACT

A method includes detecting a first movement pattern of a first device using a camera of a second device and establishing a connection between the first and second devices responsive to detecting the first movement pattern. A device includes a camera and a processor coupled to the camera, wherein the processor is to detect a first movement pattern of a second device using the camera and establish a connection with the second device responsive to detecting the first movement pattern.

### BACKGROUND

### Field of the Disclosure

The disclosed subject matter relates generally to mobile computing systems and, more particularly, to establishing a connection between devices based on detecting a movement pattern on a camera.

### Description of the Related Art

Mobile devices provide powerful platforms for communication, data exchange and collaboration. In addition to employing cellular for communication, mobile devices employ a variety of other connection types for communicating, such as Wi-Fi connections with a network or peer connections (i.e., paired connections) with other devices. Establishing such connections typically involves a configuration or pairing process that includes scanning for nearby devices (e.g., wireless access points or peer devices), selecting the intended device and entering a one-time password (OTP) or other passkeys and user ID into the mobile device. Some devices only support single peer connections. If a particular device is already paired, the user must take actions to terminate the first connection to allow pairing of a second connection. These processes may be time consuming and cumbersome.

The present disclosure is directed to various methods and devices that may solve or at least reduce some of the problems identified above.

### BRIEF DESCRIPTION OF THE DRAWINGS

The present disclosure may be better understood, and its numerous features and advantages made apparent to those skilled in the art, by referencing the accompanying drawings.

FIG. 1 is a simplified block diagram of a communication system, wherein a connection is established between devices based on detecting a camera movement pattern, in accordance with some embodiments;

FIG. 2 is a flow diagram of a method for establishing a connection between devices based on detecting a camera movement pattern, in accordance with some embodiments; and

FIG. 3 is a diagram illustrating a movement pattern employed by the system of FIG. 1, in accordance with some embodiments.

The use of the same reference symbols in different drawings indicates similar or identical items.

### DETAILED DESCRIPTION OF EMBODIMENT(S)

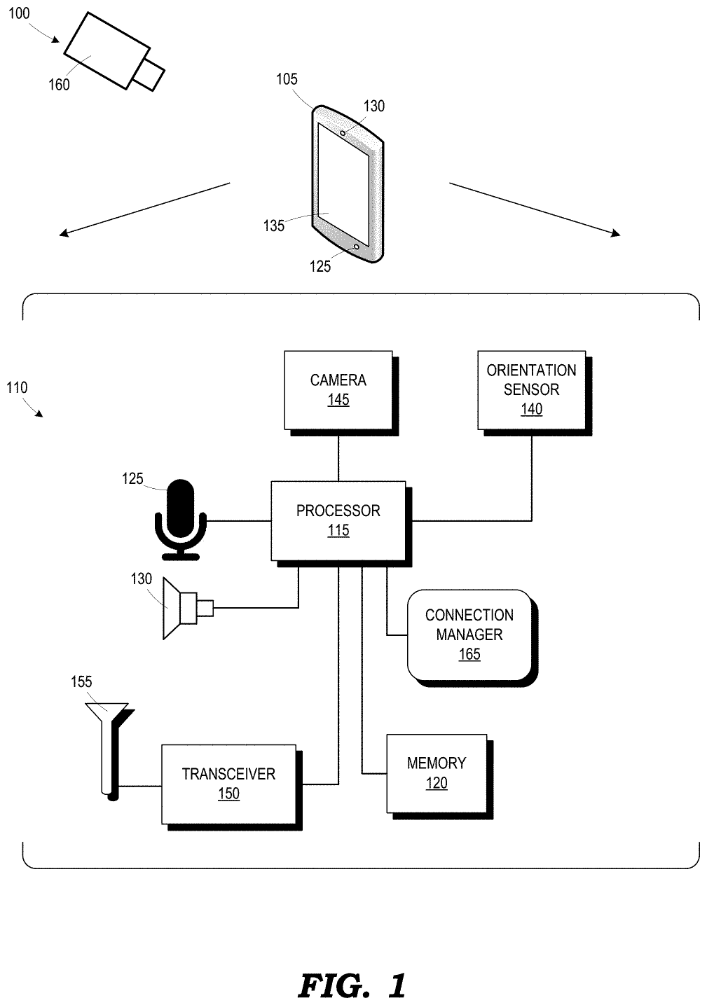

FIGS. 1-3 illustrate example techniques for establishing a connection between devices based on detecting a movement pattern on a camera. In one example, a first device including a camera may monitor its video stream to identify that a second device is moved in a particular movement pattern indicative of a connection request. The second device may also generate a movement pattern based on its internal motion sensor. The camera movement pattern may be compared to the device movement pattern to validate the identity of the second device (i.e., to distinguish the second device from other devices in the area). A connection may be established between the first and second devices.

FIG. 1 is a simplified block diagram of a communication system 100 including a device 105, in accordance with some embodiments. The device 105 implements a computing system 110 including, among other things, a processor 115, a memory 120, a microphone 125, a speaker 130, a display 135, an orientation sensor 140 (e.g., an accelerometer, magnetometer, mercury switch, gyroscope, compass or some combination thereof), and a camera 145. The memory 120 may be a volatile memory (e.g., DRAM, SRAM) or a non-volatile memory (e.g., ROM, flash memory, etc.), or a combination thereof. The device 105 includes a transceiver 150 for transmitting and receiving signals via an antenna 155. The transceiver 150 may include one or more radios for communicating according to different radio access technologies, such as cellular, Wi-Fi, Bluetooth®, ZigBee, etc. The transceiver 150 may also communicate over a packet-based communication network, such as the Internet.

As illustrated in FIG. 1, the device 105 may be positioned near a camera device 160 capable of capturing video images. The camera device 160 may have video capture as its primary function, or the camera device 160 may be equipped with a camera, but perform additional functions. In some embodiments, the camera device 160 may be an access point for a network (e.g., having a radio interface), a mobile device, a desktop computer, a laptop computer, etc. The camera device 160 may also include a computing system having some or all of the entities in the computing system 110 of the device 105, such as a processor, a memory and a transceiver. In various embodiments, the devices 105, 160 may be embodied in handheld or wearable devices, such as laptop computers, handheld computers, tablet computers, mobile devices, telephones, cameras, personal data assistants, music players, game devices, wearable computing devices and the like.

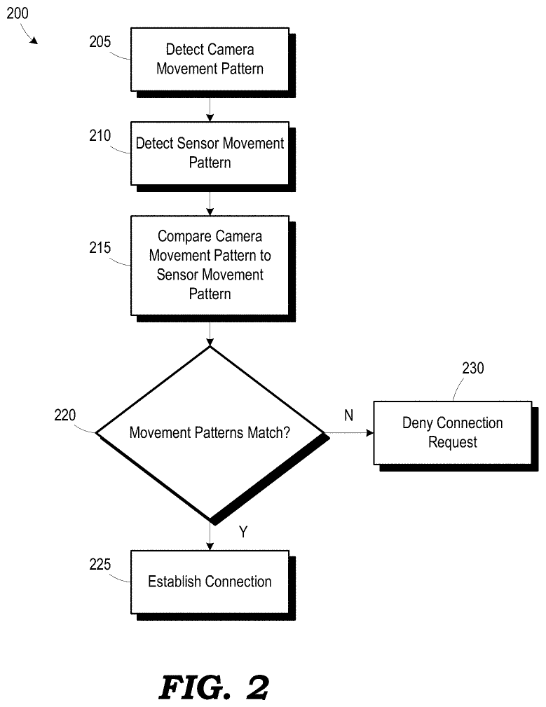

In the device 105, the processor 115 may execute instructions stored in the memory 120 and store information in the memory 120, such as the results of the executed instructions. Some embodiments of the processor 115, the memory 120 and the microphone 125 may be configured to implement a connection manager 165 and perform portions of a method 200 shown in FIG. 2 and discussed below. For example, the processor 115 may execute the connection manager 165 to establish a connection between the devices 105, 160. The connection may be initiated responsive to a trigger event (e.g., a connection request from the device 105 to the camera device 160), or the camera device 160 may continuously monitor for connection requests by monitoring its video stream to detect a predetermined movement pattern.

FIG. 2 is a flow diagram of one illustrative method for establishing a connection between devices based on detecting a camera movement pattern, in accordance with some embodiments.

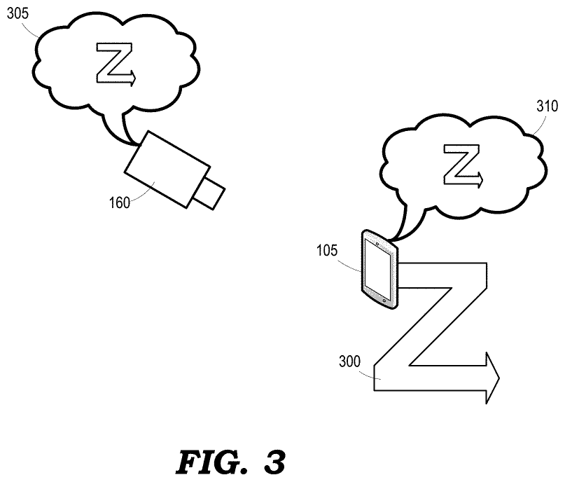

FIG. 3 is a diagram illustrating an example movement pattern 300 employed by the system of FIG. 1, in accordance with some embodiments. A user of the device 105 physically moves the device 105 according to a predetermined pattern 300 associated with a connection request. The example pattern 300 in FIG. 3 is a “Z” pattern, but other movement patterns 300 may be employed, such as a shake gesture.

In method block 205, the camera device 160 detects a camera movement pattern 305 corresponding to the movement of the device 105. In some embodiments, the camera device 160 may continuously monitor its video stream to identify the camera movement pattern 305. In some embodiments, the device 105 may signal the camera device 160 of a desire to initiate a connection, and the camera device 160 may begin monitoring its video stream responsive to the connection request.

In method block 210, the device 105 detects a sensor movement pattern 310 (e.g., using the orientation sensor 140) representing the physical movement of the device 105 according to the movement pattern 300. Techniques for generating the sensor movement pattern, such as by using rotational vectors, are known to those of ordinary skill in the art, so they are not described in detail herein to avoid obscuring the present subject matter.

In method block 215, the sensor movement pattern is compared to the camera movement pattern. In some embodiments, one of the devices 105, 160 may send its movement pattern to the other device for comparison. For example, the device 105 may send the sensor movement pattern 310 to the camera device 160. The camera device 160 may compare the patterns 305, 310.

In method block 220, a determination is made whether the patterns 305, 310 match. The determination may be made by the device 105, 160 that received the movement pattern 305, 310 from the other device. For example, the patterns 305, 310, may be represented as vectors. The vectors may be normalized, and compared to each other to generate a difference metric. If the difference metric is below a predetermined threshold, a match condition is generated.

Responsive to a movement pattern match condition being generated in method block 220, a connection is established between the devices 105, 160 in method block 225. If the movement pattern match condition is not generated, the connection request is denied in method block 230. Identification data may be exchanged between the devices 105, 160 to facilitate the connection. The connection may be peer connection (e.g., BLUETOOTH®), a Wi-Fi connection, a near field communication (NFC) connection, etc. The movement pattern matching takes the place of conventional pairing techniques, such as the exchange of a one-time password (OTP), thereby simplifying the connection process.

In some embodiments, certain aspects of the techniques described above may be implemented by one or more processors of a processing system executing software. The method 200 described herein may be implemented by executing software on a computing device, such as the processor 115 of FIG. 1, however, such methods are not abstract in that they improve the operation of the devices 105, 160 and the user's experience when operating the devices 105, 160. Prior to execution, the software instructions may be transferred from a non-transitory computer readable storage medium to a memory, such as the memory 120 of FIG. 1.

The software may include one or more sets of executable instructions stored or otherwise tangibly embodied on a non-transitory computer readable storage medium. The software can include the instructions and certain data that, when executed by one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

A method includes detecting a first movement pattern of a first device using a camera of a second device and establishing a connection between the first and second devices responsive to detecting the first movement pattern.

A device includes an orientation sensor, a transceiver, and a processor coupled to the transceiver and the orientation sensor, wherein the processor is to generate a sensor movement pattern using the orientation sensor, receive a camera movement pattern from a second device, and establish a connection to the second device using the transceiver responsive to the sensor movement pattern substantially matching the camera movement pattern.

A device includes a camera and a processor coupled to the camera, wherein the processor is to detect a first movement pattern of a second device using the camera, and establish a connection with the second device responsive to detecting the first movement pattern.

A device includes an orientation sensor, a transceiver and a processor coupled to the transceiver and the orientation sensor, wherein the processor is to generate a sensor movement pattern using the orientation sensor, send the sensor movement pattern to a second device, receive a pattern match indicator from the second device, and establish a connection to the second device using the transceiver responsive to the pattern match indicator.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

What is claimed is:

1. A method, comprising:
detecting a first movement pattern of a first device using a camera of a second device; and
establishing a connection between the first and second devices responsive to detecting the first movement pattern.

2. The method of claim 1, further comprising:
detecting a second movement pattern using an orientation sensor on the first device; and
establishing the connection responsive to the first movement pattern substantially matching the second movement pattern.

3. The method of claim 2, wherein the second movement pattern comprises a rotational vector data pattern.

4. The method of claim 2, further comprising communicating the first movement pattern from the first device to the second device, wherein the second device compares the first and second movement patterns.

5. The method of claim 2, further comprising communicating the second movement pattern from the second device to the first device, wherein the first device compares the first and second movement patterns.

6. The method of claim 1, further comprising exchanging identification data between the first and second devices responsive to the first movement pattern matching the second movement pattern.

7. The method of claim 1, wherein establishing the connection comprises pairing the first and second devices.

8. The method of claim 1, wherein establishing the connection comprises establishing a Wi-Fi connection.

9. The method of claim 3, wherein the second device comprises a Wi-Fi radio interface coupled to the camera.

10. The method of claim 1, further comprising:
sending a connection request signal from the first device to the second device; and
enabling the camera in the second device responsive to the connection request signal.

11. A device, comprising:
an orientation sensor;
a transceiver; and
a processor coupled to the transceiver and the orientation sensor, wherein the processor is to generate a sensor movement pattern using the orientation sensor, receive a camera movement pattern from a second device, and establish a connection to the second device using the transceiver responsive to the sensor movement pattern substantially matching the camera movement pattern.

12. The device of claim 11, wherein the sensor movement pattern comprises a rotational vector data pattern.

13. The device of claim 11, wherein the processor is to exchange identification data with the second device responsive to the sensor movement pattern substantially matching the camera movement pattern.

14. The device of claim 11, wherein the connection comprises a paired connection.

15. The device of claim 11, wherein the connection comprises a Wi-Fi connection.

16. The device of claim 11, wherein the processor is to send a connection request signal to the second device prior to generating the sensor movement pattern.

17. A device, comprising:
a camera; and
a processor coupled to the camera, wherein the processor is to detect a first movement pattern of a second device using the camera, and establish a connection with the second device responsive to detecting the first movement pattern.

18. The device of claim 17, wherein the processor is to receive a second movement pattern from the second device, and establish the connection responsive to the first movement pattern substantially matching the second movement pattern.

19. The device of claim 17, wherein the processor is to communicate the first movement pattern to the second device, receive a pattern match indicator from the second device, and establish the connection responsive to receiving the pattern match indicator.

20. The device of claim 17, wherein the processor is to receive a connection request signal from the second device and enable the camera to detect the first movement pattern responsive to the connection request signal.

21. A device, comprising:
an orientation sensor;
a transceiver; and
a processor coupled to the transceiver and the orientation sensor, wherein the processor is to generate a sensor movement pattern using the orientation sensor, send the sensor movement pattern to a second device, receive a pattern match indicator from the second device, and establish a connection to the second device using the transceiver responsive to the pattern match indicator.

22. The device of claim 21, wherein the sensor movement pattern comprises a rotational vector data pattern.

23. The device of claim 21, wherein the connection comprises a paired connection.

24. The device of claim 21, wherein the connection comprises a Wi-Fi connection.

25. The device of claim 21, wherein the processor is to send a connection request signal to the second device prior to generating the sensor movement pattern.
